(19) United States
(12) Patent Application Publication
(10) Pub. No.: US 2017/0223236 A1
(43) Pub. Date: Aug. 3, 2017

(54) Wearable Camera Apparatus

(71) Applicant: Pinchus Oberlander, Brooklyn, NY (US)

(72) Inventor: Pinchus Oberlander, Brooklyn, NY (US)

(21) Appl. No.: 15/234,972

(22) Filed: Aug. 11, 2016

Related U.S. Application Data
(60) Provisional application No. 62/203,601, filed on Aug. 11, 2015.

(51) Int. Cl. H04N 5/225; G03B 17/56; A45F 5/02; F16M 13/04; F16M 13/00; H04N 5/232; F16B 2/20

(52) U.S. Cl. CPC H04N 5/2252; H04N 5/2253; H04N 5/2254; H04N 5/23245; G03B 17/561; H04N 5/23296; H04N 5/23212; H04N 5/23216; F16B 2/20; H04N 5/23203; F16M 13/04; F16M 13/005; A45F 5/02; A45F 2200/0533; H04M 1/0202

(57) ABSTRACT

A wearable camera apparatus for taking photographs and videos is provided. The wearable camera apparatus comprises a camera housing and a camera mounted within the camera housing. A lens is mounted on the camera housing with the lens being in visual communication with the camera. A power button is mounted to the camera housing with the power button alternatingly depressible to power the camera on and to power the camera off. A selecting mechanism selects between photographs and videos. A mounting system is secured to the camera housing for releasably securing the camera housing to an object. The camera providing a simple and accessible means of capturing pictures and video.

### CLAIM OF PRIORITY

This patent application claims priority under 35 USC 119 (e) (1) from U.S. Provisional Patent Application Ser. No. 62/203,601 filed Aug. 11, 2015, of common inventorship herewith entitled, “Bluetooth Camera Clip,” which is incorporated herein by reference as though the same were set forth in its entirety.

### FIELD OF THE INVENTION

The present invention pertains to the field of cameras, and more specifically to the field of attachable, wearable cameras.

### BACKGROUND OF THE INVENTION

A favorite means of preserving memories is through photography. A photograph provides a lasting keepsake of special moments in life. A baby's first steps, a child's first day of school, a college graduation or a loved one's wedding can all be beautifully captured on film, providing an instant reminder of a cherished day. Photography also can record those often overlooked, candid moments which make life so special. Children skipping over a sprinkler, two elderly men playing chess in the park, or a young couple sharing a tender moment are memories soon forgotten if never printed in living color or black and white. Powerful and dynamic, a photograph provides a visual reminder of family, friends and events, while affording future generations a glimpse into the past.

For professional and amateur photographers alike, certain tools of the trade enable them to take beautiful photographs. The most important tool of any photographer is their camera. While there are a seemingly endless variety of cameras available on the market, perhaps the most popular is the digital camera. Although digital cameras come at a higher price than their film counterparts, many serious photographers are finding their many benefits justify the expense. Compact with built in auto focus and stop action capabilities, a digital camera is more conducive to capturing a quick snap of an impromptu photo or even video opportunity. However, a digital camera has limitations when a photographer spots an inspiring shot while behind the steering wheel of a car. Whether a majestic mountain scape along a highway, a costumed pedestrian or a clever bumper sticker on an auto, such moments are elusive to the driver who is unable to grab, adjust, point and shoot a camera while concentrating on their driving. Since photo equipment is awkward and cumbersome, many photographers leave their cameras behind when engaging in everyday activities.

The prior art has put forth several designs for eyeglasses with attachable cameras. Among these are:

U.S. Pat. No. 8,068,169 to Byung Jin Chang describes a video camera system that includes a mount with a clip on structure adapted for attachment to a pair of eyeglass frames, loupes, or a headband. The preferred embodiment includes a camera mounted on a first pivot arm, and a light source mounted on a second pivot arm. One or both of the pivot arms are rotatable, enabling the beam from the light source and field of view of the camera to be aligned for a given working distance. Polarizing filters may be mounted to the camera, light source or both, to control glare, reflection or other undesired visual artifacts.

U.S. Pat. No. 7,806,525 to Thomas A. Howell, David Chao, C. Douglass Thomas and Peter P. Tong describes a pair of glasses with a camera that is partially or fully embedded in the glasses. In another embodiment, the camera is removably attached to the glasses, such as removably attached to a temple of the glasses. The glasses also include one or more various other electrical components. These other electrical components work separately or in conjunction with the camera.

U.S. Pat. No. 7,059,717 to Nigel K. Bloch describes an eyeglass apparatus and transformation system thereof, facilitating quick and easy convertibility of the left and right traditionally folding temples into an adjustable headband, thereby making the lightweight eyeglasses much more suited to dynamic activities such as jogging, skiing and cycling. A user can advantageously move between more sedentary situations, where the extreme appearance of eye goggles appear very out of place. By manually releasing an inconspicuously integrated pair of bifurcated retention latches located immediately aftward of both temple hinges, the temples are instantly detachable and readily interchangeable with a headband employing similar slide in, bayonet type retention latches. The disclosure identifies a particularly critical human factor problem addressed by the uniquely configured finger operated, opposed latches. The slim lined, detachable temples facilitate a host of optional companion accessory temple embodiments including a miniature radio, cell phone or digital camera.

None of these prior art references describe the present invention.

### SUMMARY OF THE INVENTION

It is an object of the present invention to provide a compact picture and video camera that fits on the frames of eyeglasses or sunglasses.

The present invention is a wearable camera apparatus for taking photographs and videos. The wearable camera apparatus comprises a camera housing and a camera mounted within the camera housing. A lens is mounted on the camera housing with the lens being in visual communication with the camera. A power button is mounted to the camera housing with the power button alternatingly depressible to power the camera on and to power the camera off. A selecting mechanism selects between photographs and videos. A mounting system is secured to the camera housing for releasably securing the camera housing to an object. The camera providing a simple and accessible means of capturing pictures and video.

In addition, the present invention further includes a method for taking photographs and videos. The method comprises providing a camera housing, mounting a camera within the camera housing, mounting a lens on the camera housing, visually communicating between the lens and the camera, mounting a power button to the camera housing, alternatingly depressing the power button to power the camera on and to power the camera off, selecting between photographs and videos, releasably securing the camera housing to an object, and providing a simple and accessible means of capturing pictures and video.

The present invention further includes a wearable camera apparatus for taking photographs and videos. The wearable camera apparatus comprises a camera housing having a substantially cuboid or cube shape with the camera housing having a front surface, a rear surface, a top surface, a bottom surface, a first side surface, and a second side surface. A camera is mounted within the camera housing. A lens is mounted on the front surface of the camera housing with the lens being in visual communication with the camera. A power button is mounted on the top surface of the camera housing with the power button alternatingly depressible to power the camera on and to power the camera off. A photo button is mounted on the top surface of the camera housing. A video button is mounted on the top surface of the camera housing. A mounting system is secured to second side surface of the camera housing for releasably securing the camera housing to an object. The camera provides a simple and accessible means of capturing pictures and video.

### BRIEF DESCRIPTION OF THE DRAWINGS

FIG. 1 is a perspective view illustrating a wearable camera apparatus, constructed in accordance with the present invention, showing a camera with a camera lens and an attachment clip and having a video button, a photo button, and a power on and off button.

FIG. 2 is a perspective view illustrating the wearable camera apparatus, constructed in accordance with the present invention, showing the camera with the camera lens and the attachment clip and having the video button, the photo button, and the power on and off button.

FIG. 3 is a perspective view illustrating the wearable camera apparatus, constructed in accordance with the present invention, with the camera releasably attached to a frame of eyeglasses.

FIG. 4 is a perspective view illustrating a smartphone containing an application for downloading photos and video from the wearable camera apparatus, constructed in accordance with the present invention, to the smartphone by means of Bluetooth or other compatible technology.

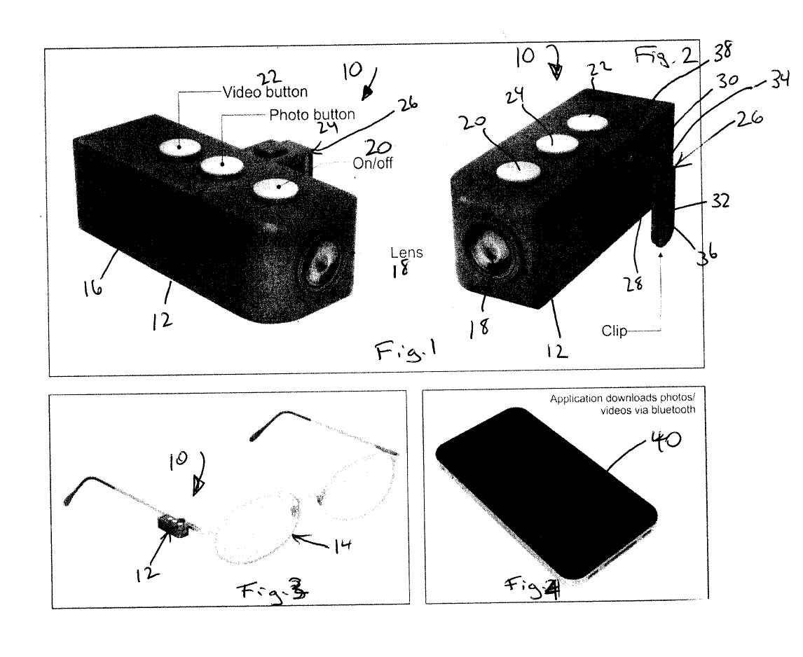

### DETAILED DESCRIPTION OF THE INVENTION

The present invention, hereinafter referred to as a Wearable Camera Apparatus, indicated generally at 10, is a compact picture and video camera 12 that releasably mounts on the frames 13 of eyeglasses or sunglasses 14 or on any other place. Controlled by an external device such as a smartphone or a tablet computer, the camera 12 of the Wearable Camera Apparatus 10 of the present invention provides both professional and amateur photographers with a simple and accessible means of capturing pictures and video wherever they may be.

The Wearable Camera Apparatus 10 of the present invention includes a camera 12 enclosed within a camera housing 16. The camera 12 of the present invention is a state of the art, digital model with many features inherent in top of the line cameras including automatic zoom and focus, self-setting, and stop action lens for both time lapse pictures and videography.

The camera housing 16 of the Wearable Camera Apparatus 10 of the present invention preferably has a substantially cuboid or cube shape although having a camera housing 16 with a different shape is within the scope of the present invention. In the preferred embodiment, the camera housing 16 has a front surface, a rear surface substantially opposite the front surface, a top surface, a bottom surface substantially opposite the top surface, a first side surface, and a second side surface substantially opposite the first side surface. In a preferred embodiment, the camera housing 16 is small and compact measuring approximately one-half (½″) inch in height, one-half (½″) inch in depth, and one and one-half (1½″) inches in width although constructing the camera housing 16 with different measurements is within the scope of the present invention.

In addition, the Wearable Camera Apparatus 10 of the present invention includes a lens 18 mounted on the front surface of the camera housing 16. The lens 18 is in visual communication with the camera 12 positioned within the camera housing 16. It should be noted that any type of photography lens 18 is within the scope of the present invention and the present invention should not be limited by any particular type of lens 18 described or illustrated herein.

The Wearable Camera Apparatus 10 of the present invention further includes a power button 20 preferably mounted to the top surface of the camera housing 16. The power button 20 can be depressed to power the camera 12 on and then depressed again to power the camera 12 off. Instead of being a depressible button, the power button 20 can also be a toggle or other type of switch depending on the desires of the manufacturer and/or end user.

Furthermore, the Wearable Camera Apparatus 10 of the present invention includes a video button 22 and a photo button 24 preferably mounted to the top surface of the camera housing 16. Preferably, in a default mode upon powering up the camera 12, the camera 12 presents itself in the photography mode capable of taking a photograph of a desired subject. Upon depressing the video button 22, the camera 12 changes to a video mode capable of taking videos, rather than still photographs. To change back into the photography mode, the user simply depresses the photo button 24 thereby allowing the camera 12 to take still photographs once again.

Further yet, the Wearable Camera Apparatus 10 of the present invention includes a mounting system 26 secured to one of the surfaces of the camera housing 16. In a preferred embodiment, the mounting system 26 is an attachment clip mounted to the second side surface of the camera housing 16. The attachment clip 28 is configured to releasably secure the camera 12 to the eyeglass or sunglass frames 13 or any other desire object. It should be noted that while the mounting system 26 has been described and illustrated as being an attachment clip 28, it is within the scope of the present invention for the mounting system 26 to by any type of mounting system 26 capable of releasably securing the camera 12 to the eyeglass or sunglass frames 13.

The attachment clip 28 of the Wearable Camera Apparatus 10 of the present invention includes a clip housing 30 secured directly to the second side of the camera housing 16 and an adjusting stem 32 having a mounting portion 34 and a securing portion 36 angled from the mounting portion 34. In a preferred embodiment, the securing portion 36 of the adjusting stem 32 is approximately perpendicular to the mounting portion 34. The clip housing 30 has an aperture for slidably receiving the mounting portion 34 of the adjusting stem 32 within the aperture of the clip housing 30. A push button locking mechanism 38, tightening knob, or the like extends through the clip housing 30 tightenable against the mounting portion 34 of the adjusting stem 32 to releasably secure the adjusting stem 32 in a desired location. Friction can also be used to releasably secure the adjusting stem 32 in the desired location.

In practice of the Wearable Camera Apparatus 10 of the present invention, the eyeglass or sunglass frame 13 is positioned between the securing portion 36 of the adjusting stem 32 and the second side surface of the camera housing 16. The adjusting stem 32 is then manipulated toward the second side surface of the camera housing 16 thereby sandwiching the eyeglass or sunglass frame 13 between the securing portion 36 of the adjusting stem 32 and the second side surface of the camera housing 16. Upon activating the push button locking mechanism 38, tightening of the tightening knob against the mounting portion 34 of the adjusting stem 32, or friction, the camera 16 is releasably securable to any sized eyeglass frame 13.

To assist in operation, the camera 12 of the Wearable Camera Apparatus 10 of the present invention possesses Bluetooth capability for syncing the camera 12 to an electronic smartphone 40 or tablet computer. The smartphone 40 or tablet computer has downloaded a software or application (using the internet) programmed allowing the user to use the keypads of these electronics to zoom, focus, snap, and record. All photographs and videos are saved directly to the software or application. If there is no internet connection, the user will have the option to connect via Bluetooth and have the same features as stated previously. Finally, the camera 12 can have a slot for receiving an SD card so all the images and videos can be saved direct on the camera 12. This feature will be very helpful when there is no internet connection and using the Bluetooth feature.

The Wearable Camera Apparatus 10 of the present invention is installable and ready for use in a matter of minutes. If a photo or video opportunity captures the eye of a user, only one hand is needed to launch the application of the Wearable Camera Apparatus 10. With the camera lens 18 of the camera 12 aimed at the subject, a user simply presses the appropriate buttons on the camera housing 16 to secure the shot. Pictures and video are taken at a moment's notice as the auto focus and speed settings take care of themselves without the need of manual adjustment.

A technologically advanced digital camera 12 securely mounted to the framework 13 of eyewear 14, the camera 12 of the Wearable Camera Apparatus 10 of the present invention facilitates picture taking and video filming with a bare minimum of operation by the user. The camera 12 is instantly ready to snap the most spontaneous of subjects without a driver worrying about losing attention for safe driving or lamenting they have left their photographic equipment at home. Whether driving behind a wheel, performing a physical activity, or wanting to record an event, the camera of the Wearable Camera Apparatus 10 of the present invention functions as a safe, hassle free and hands free method of capturing special moments on camera. Durably constructed with fully encompassing functionality, the Wearable Camera Apparatus 10 presents limitless capabilities for photographers of all skill levels.

Also, a big feature of the Wearable Camera Apparatus 10 of the present invention is that the camera 12 and a cell phone work together. In other words, the camera 12 has all the options and features that smartphones offer today as in colors, shades, panoramic views, etc. the options are available on the phone/tablet and the lens 18 of the camera 12 is situated on the users eyeglasses. Also, the camera 12 is preferably waterproof and has a flash for night photos and videos.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A wearable camera apparatus for taking photographs and videos, the wearable camera apparatus comprising:
a camera housing;
a camera mounted within the camera housing;
a lens mounted on the camera housing, the lens being in visual communication with the camera;
a power button mounted to the camera housing, the power button alternatingly depressible to power the camera on and to power the camera off;
selecting means for selecting between photographs and videos; and
a mounting system secured to the camera housing for releasably securing the camera housing to an object;
wherein the camera provides a simple and accessible means of capturing pictures and video.

2. The wearable camera apparatus of claim 1 wherein the camera is a digital camera having automatic zoom and focus, self-setting, and stop action lens for both time lapse pictures and videography.

3. The wearable camera apparatus of claim 1 wherein the camera housing has a substantially cuboid or cube shape, the camera housing having a front surface, a rear surface, a top surface, a bottom surface, a first side surface, and a second side surface.

4. The wearable camera apparatus of claim 3 wherein the lens is mounted on the front surface of the camera housing.

5. The wearable camera apparatus of claim 3 wherein the power button is mounted to the top surface of the camera housing.

6. The wearable camera apparatus of claim 1 and further comprising:
a photo button mounted to the camera housing; and
a video button mounted to the camera housing.

7. The wearable camera apparatus of claim 6 wherein upon powering up the camera, the camera presents itself in the photography mode capable of taking a photograph of a desired subject, and wherein upon depressing the video button, the camera changes to a video mode capable of taking videos.

8. The wearable camera apparatus of claim 3 and further comprising:
wherein the selecting means is mounted to the top surface of the camera housing.

9. The wearable camera apparatus of claim 3 wherein the mounting system is mounted to the second side surface of the camera housing.

10. The wearable camera apparatus of claim 1 wherein the mounting system is an attachment clip, the attachment clip comprising:
a clip housing secured directly to the camera housing, the clip housing having an aperture formed therein;
an adjusting stem having a mounting portion and a securing portion angled from the mounting portion, the mounting portion of the adjusting stem slidably receivable within the aperture of the clip housing; and
a securement mechanism extending through the clip housing against the mounting portion of the adjusting stem to releasably secure the adjusting stem in a desired location.

11. The wearable camera apparatus of claim 1 and further comprising:
an operating system selected from the group consisting of software or application with photographs and videos are saved directly to the software or application, Bluetooth wireless connectivity, and a slot formed in the camera for receiving an SD card so all the images and videos can be saved direct on the camera.

12. The wearable camera apparatus of claim 11 wherein the smartphone or tablet computer has a software application programmed allowing the camera to zoom, focus, snap, and record.

13. A method for taking photographs and videos, the method comprising:
providing a camera housing;
mounting a camera within the camera housing;
mounting a lens on the camera housing;
visually communicating between the lens and the camera;
mounting a power button to the camera housing;
alternatingly depressing the power button to power the camera on and to power the camera off;
selecting between photographs and videos;
releasably securing the camera housing to an object; and
providing a simple and accessible means of capturing pictures and video.

14. A wearable camera apparatus for taking photographs and videos, the wearable camera apparatus comprising:
a camera housing having a substantially cuboid or cube shape, the camera housing having a front surface, a rear surface, a top surface, a bottom surface, a first side surface, and a second side surface;
a camera mounted within the camera housing;
a lens mounted on the front surface of the camera housing, the lens being in visual communication with the camera;
a power button mounted on the top surface of the camera housing, the power button alternatingly depressible to power the camera on and to power the camera off;
a photo button mounted on the top surface of the camera housing; and
a video button mounted on the top surface of the camera housing; and
a mounting system secured to second side surface of the camera housing for releasably securing the camera housing to an object;
wherein the camera provides a simple and accessible means of capturing pictures and video.

15. The wearable camera apparatus of claim 14 wherein the camera is a digital camera having automatic zoom and focus, self-setting, and stop action lens for both time lapse pictures and videography.

16. The wearable camera apparatus of claim 14 wherein upon powering up the camera, the camera presents itself in the photography mode capable of taking a photograph of a desired subject, and wherein upon depressing the video button, the camera changes to a video mode capable of taking videos.

17. The wearable camera apparatus of claim 14 wherein the mounting system is an attachment clip, the attachment clip comprising:
a clip housing secured directly to the camera housing, the clip housing having an aperture formed therein;
an adjusting stem having a mounting portion and a securing portion angled from the mounting portion, the mounting portion of the adjusting stem slidably receivable within the aperture of the clip housing; and
a securement mechanism extending through the clip housing against the mounting portion of the adjusting stem to releasably secure the adjusting stem in a desired location.

18. The wearable camera apparatus of claim 17 wherein the securement mechanism is friction.

19. The wearable camera apparatus of claim 14 and further comprising:
Bluetooth wireless connectivity for syncing the camera to an electronic smartphone or tablet computer.

20. The wearable camera apparatus of claim 19 wherein the smartphone or tablet computer has a software application programmed allowing the camera to zoom, focus, snap, and record.
